(19) United States
(12) Patent Application Publication
(10) Pub. No.: US 2025/0390624 A1
(43) Pub. Date: Dec. 25, 2025

(54) METHOD AND SYSTEM FOR DESIGNING A HIGH VOLTAGE BATTERY SYSTEM FOR AN ELECTRIC VEHICLE

(71) Applicant: FCA US LLC, Auburn Hills, MI (US)

(72) Inventors: Dipan Pradeepkumar Arora, Auburn Hills, MI (US); Alaa Edeen El-Sharkawy, Auburn Hills, MI (US); Amr Gamal Samy Sayed, Auburn Hills, MI (US)

(21) Appl. No.: 18/749,690

(22) Filed: Jun. 21, 2024

(51) Int. Cl. G06F 30/15; B60L 50/60

(52) U.S. Cl. CPC G06F 30/15; B60L 50/60

(57) ABSTRACT

A method and system for designing a battery system includes generating a geometric model for a battery system based on a plurality of design requirement data, analyzing the geometric model with an engineering physics simulation tool, performing a parametric analysis of the geometric model of the battery system using material properties and boundary conditions to obtain a plurality of battery system design data and selecting a selected battery system design from the plurality of battery system design data based on selection characteristics.

### FIELD

The present disclosure relates to a high voltage batteries for electric vehicles, and, more specifically, to a system and method for thermal protection and management of high voltage batteries.

### BACKGROUND

This section provides background information related to the present disclosure which is not necessarily prior art.

Electric vehicles (EVs) are becoming more popular due to their environmental benefits and economic advantages. However, one of the main challenges for EVs is the thermal management of their high voltage batteries, which are essential for providing power and energy to the vehicle. High voltage batteries are subject to various thermal loads, such as ambient temperature, internal heat generation, charging and discharging cycles, and external cooling or heating sources. The thermal loads can affect the performance, safety, and lifespan of the batteries, and therefore, require adequate thermal protection and management systems. Existing methodologies often rely on physical testing, which can be time-consuming and expensive. There is a need for a more efficient and cost-effective approach.

The industry has relied on several traditional methods to address the thermal management of high voltage batteries in electric vehicles (EVs). Physical Testing is the most common approach in which a physical prototypes of the battery systems are built and tested under various conditions. This process was often time-consuming and expensive, as it required building multiple prototypes and setting up different testing environments. Moreover, it was challenging to cover all possible operating conditions, leading to potential gaps in the testing coverage.

Analytical models have been used by some designers used analytical models to predict the thermal behavior of battery systems. However, these models often relied on simplifying assumptions and might not accurately capture the complex interactions between different components and systems at various scales.

Passive thermal management systems, such as heat sinks and thermal pads, have been used to dissipate heat from the batteries. While these systems were relatively simple and reliable, they might not provide sufficient cooling under high load conditions or rapid charging and discharging scenarios. Furthermore, there is a risk of under-designing these systems, leading to inadequate thermal protection.

Active thermal management systems, such as liquid cooling or air cooling, are used to provide more effective cooling. However, these systems added complexity to the vehicle design and required additional energy to operate, potentially reducing the overall efficiency of the vehicle. There is a risk of under-designing these systems, resulting in suboptimal performance and potential safety issues.

Despite these efforts, the industry faced significant challenges in efficiently managing the thermal behavior of high voltage batteries in EVs. The existing solutions were often not sufficient to fully address the complex thermal issues associated with these batteries, highlighting the need for a more effective and comprehensive approach.

### SUMMARY

This section provides a general summary of the disclosure and is not a comprehensive disclosure of its full scope or all of its features.

The present disclosure provides a novel methodology for the design of thermal protection and management systems for high voltage batteries in electric vehicles. This methodology leverages virtual engineering physics simulation tools, enabling designers to predict and mitigate potential thermal issues at the vehicle-level, thereby enhancing the safety, performance, and lifespan of the batteries.

The present disclosure involves several steps. First, a detailed 3D model of the electric vehicle and its high voltage battery system is created. Next, this model is imported into a virtual engineering physics simulation tool. The tool is then used to simulate various operating conditions and scenarios, such as different driving patterns, ambient temperatures, and cooling strategies.

The simulation results provide valuable insights into the thermal behavior of the battery system under different conditions. These insights can be used to optimize the design of the thermal protection and management system, for example by improving the placement of cooling elements or by adjusting the control strategies for active cooling systems.

The present methodology allows for rapid iteration and optimization of designs, significantly reducing the time and cost associated with physical testing. Furthermore, it enables more comprehensive testing under a wide range of conditions, leading to safer and more reliable battery systems.

The methodology provides a comprehensive approach to designing thermal protection and management systems that can be customized for different types of electric vehicle high voltage batteries.

In one aspect of the disclosure, a method includes generating a geometric model for a battery system based on a plurality of design requirement data, analyzing the geometric model with an engineering physics simulation tool, performing a parametric analysis of the geometric model of the battery system using material properties and boundary conditions to obtain a plurality of battery system design data and selecting a selected battery system design from the plurality of battery system design data based on selection characteristics.

In one aspect of the disclosure, a method includes a processor, a non-transitory computer readable medium including machine readable instructions that are executable by a processor. The machine readable instructions include, generating a geometric model for a battery system based on a plurality of design requirement data, analyzing the geometric model based with an engineering physics simulation tool, performing a parametric analysis of the battery system model using material properties and boundary conditions to obtain a plurality of battery system design data, and selecting a selected battery system design from the plurality of battery system design data based on selection characteristics.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a block diagrammatic view of a vehicle having a battery.

FIG. 2 is a block diagrammatic view of a battery design system.

FIG. 3 is a flowchart of a method for designing a battery system.

Corresponding reference numerals indicate corresponding parts throughout the several views of the drawings.

### DETAILED DESCRIPTION

Example embodiments will now be described more fully with reference to the accompanying drawings.

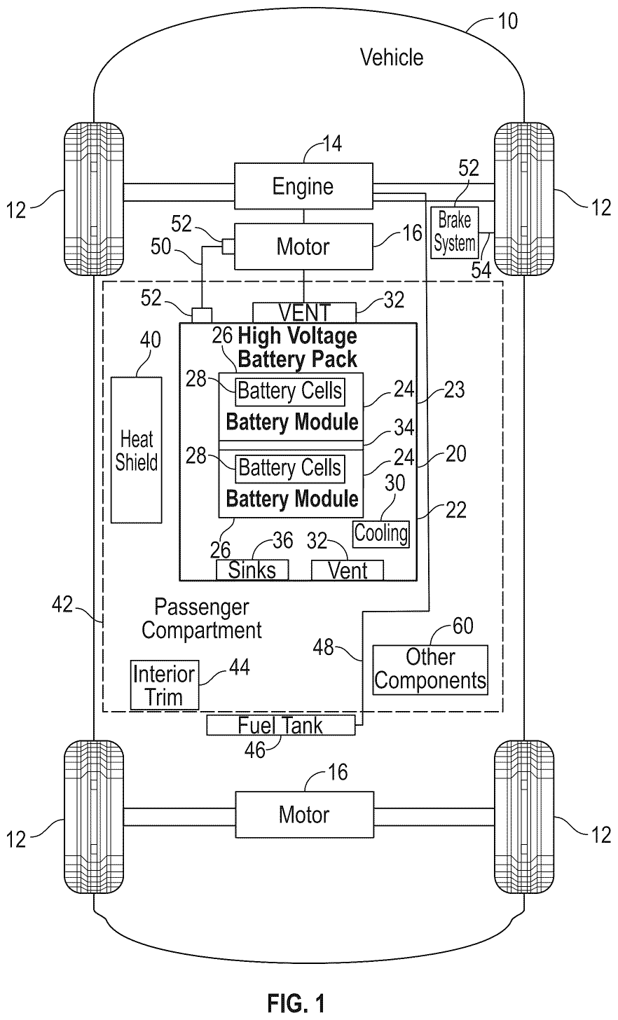

Referring now to FIG. 1, a block diagrammatic representation of a vehicle 10 is shown. The vehicle has a plurality of wheels 12 that are powered by an engine 14, electric motors 16 or combinations of both. That is, the vehicle 10 may be a battery electric vehicle or a hybrid electric vehicle. The vehicle 10 has a high voltage battery pack 20 that has a plurality of walls 22 that form a battery pack housing 23 that enclose a plurality of battery modules 24. The plurality of battery modules 24 have a housing 26 that enclose a plurality of battery cells 28. The battery pack 20 may have various battery pack layouts and components such as cooling components, thermal isolation layers and different chemistries within each of the battery cells 28. The position of the battery modules 24 and the battery cells 28 are referred to as the battery cell layout. Although only two battery modules 24 are illustrated, a large number of battery modules 24 are likely in any particular vehicle. Various numbers of battery cells 28 are provided in each of the battery modules 24.

Various cooling structures 30 may also be provided within the battery pack 20. Likewise, various numbers of vents 32 may be provided. In this example, two vents 32 located on the longitudinal ends of the battery pack 20 are illustrated. However, various numbers of vents 32 may be provided.

In summary, the battery cells 28 each have a chemistry, a layout and construction. The battery modules 24 have a housing and thermal isolation layers 34. The battery pack 20 may have various layouts depending upon the type of vehicle and the vehicle geometry. The battery pack 20 may also have various components, such as cooling components 30, disposed therein. The battery pack 20 may also have a plurality of vents 32 that are disposed in various locations and may be various sizes. Further, a plurality of heat sinks 36, one of which is illustrated, may be employed to remove heat.

A heat shield 40 is disposed adjacent to the battery pack 20. In this illustration, the heat shield 40 is located next to the battery pack 20 for convenience of the drawing. However, the heat shield 40 may be disposed in various positions including between the passenger compartment 42 and the battery pack 20. The passenger compartment 42 has interior trim 44.

The vehicle 10 may also include a fuel tank 46 that is coupled to the engine 14 through a fuel line 48. Cables 50 and connectors 52 may also connect a plurality of different components such as the battery pack 20 and the motor 16.

The vehicle 10 may also have a brake system 52 with a brake line 54 that is coupled to each of the wheels 12 to stop the vehicle 10. Each of the above-mentioned components has a smoking or melting point for which it is desirable to keep the temperature below during operation. The heat shield 40 may be one continuous component or a plurality of individual portions.

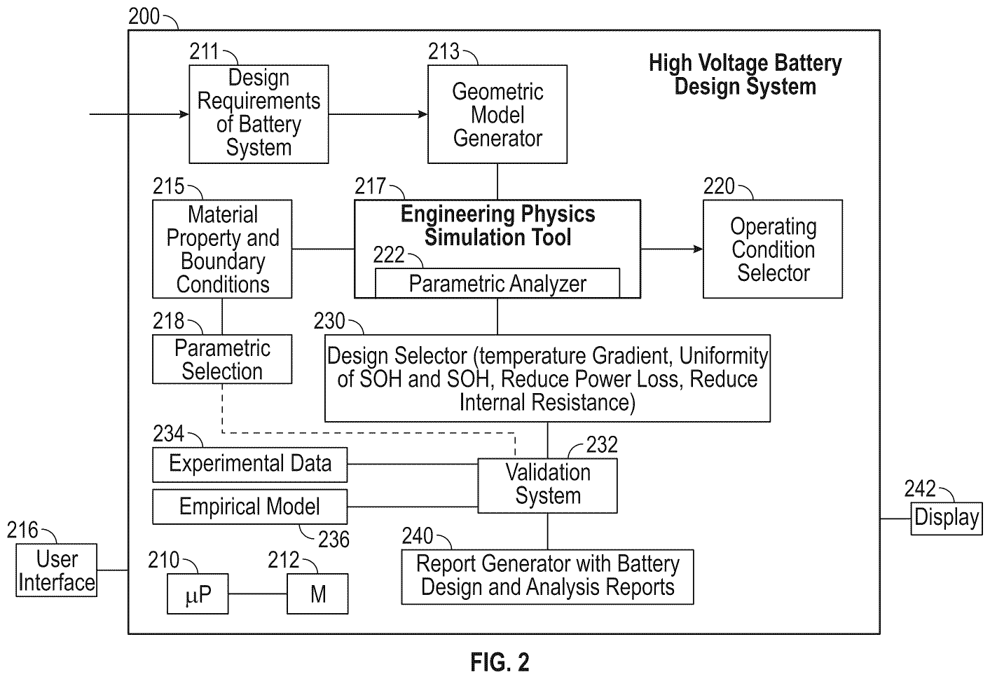

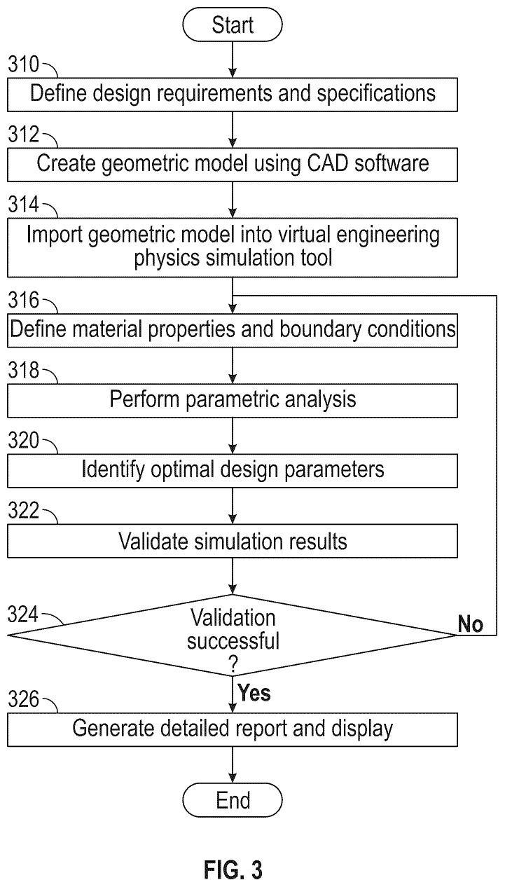

Referring now to FIGS. 2 and 3, a battery design system 200 and a method for designing are set forth. The battery design system 200 may comprise a microprocessor or processor 210 in communication with a memory 212. The memory 212 may be used for storing various intermediate results and conditions to be used in determining the design and the output of the high voltage battery design. The memory 212 is a non-transitory computer readable medium including machine readable instructions that are executable by the processor 210 that perform the various determinations for selecting and forming the high voltage battery design. The microprocessor 210 may also be coupled to a user interface 216 such as a keyboard, touch screen or another data entry device.

The high voltage battery design device 200 may be formed of one component or a plurality of components that intercommunicate to form a high voltage battery design and generate an analysis report therefor. The high voltage battery design device 200 is specifically used to design the high voltage battery for thermally protecting the battery pack 20 and the vehicle 10 of FIG. 1.

The high voltage battery design device 200 has a design requirement input which is provided at step 310 of the method. The design requirement input includes but is not limited to providing the design requirements as specification for the battery system such as the battery size, battery shape, battery weight, battery capacity, battery power, battery energy density, battery operating temperature range, battery cooling methods and the like. The design requirements may be provided to the design device 200 through the user interface 216. A geometric model generator 213 is used for creating a three-dimensional geometric model of the battery system using computer aid design (CAD) as set forth in step 312 of FIG. 3. The geometric model of the battery system may include the details of the battery cells, the battery modules, the battery packs, the connectors, the cable, the sensors, the housing materials, the vents for the module, the heat shield of the module and various vehicle constraints such as the floor of the vehicle and other geometric limitations of the vehicle and battery system. Ultimately, the geometric model in step 314 is imported into an engineering physics simulation tool 214. The engineering physics simulation tool 214 also receives parameters of the material properties and boundary conditions 215. A parametric selector 218 may be used to select various parameters from the material properties and boundary conditions that are used in the physics simulation tool 214. An operating condition selector 220 is used for changing the operating conditions of the physics simulation tool. For a vehicle environment, various speeds, cooling rates and ambient temperature for a complete simulation of the parameters in a range of vehicle operating conditions. The material properties and boundary conditions 215 are selected in step 316. Ultimately, a parametric analyzer 222 is used to perform parametric analysis as set forth in step 318. The various material properties and boundary conditions 215 include but are not limited to electrical conductivity, thermal conductivity, specific heat capacity, density, thermal expansion, coefficient, heat generation rate, heat transfer coefficient and the like. The operating condition selector 220 may vary the operating condition such as the ambient temperature that are provided to the engineering physics simulation tool 217.

The parametric analyzer 222 performs a parametric analysis in step 318. The parametric analysis analyzer 222 may vary the cell arrangement, the cell spacing, the battery cell size, the battery cell shape, the cooling method, the cooling fluid type, the cooling fluid flow rate and the like. The parametric analysis analyzer 222 determines changes in the temperature distribution, voltage distribution, state of charge (SOC), the state of health (SOH), internal resistance and power loss. The simulation tool 217 ultimately evaluates electrical phenomena, thermal phenomena, mechanical phenomena and chemical phenomena of the battery system design based on the parameters and operating conditions.

The design device has a design selector 230 that identifies the optimum design parameters as simulated in the simulation tool with the parametric analyzer 222. Ultimately, design guide performance parameters are generated by the design selector. Step 320 is used to identify the optimal design parameters that are used to meet the design requirements and specifications of the battery from block 211. Battey design data may be chosen based on selection characteristics for achieving different objectives, including but not limited to, minimizing the temperature gradient within the battery such as within the battery pack, the battery modules or the battery cells. Likewise, design guide performance parameters may also include maximizing the uniformity of the state of charge, maximizing the uniformity of the state of health, reducing the power loss and reducing the internal resistance of the battery pack. The output of a design selector 230 is used to obtain a battery system design that specifies the data corresponding to the battery cells, modules, battery packs, connectors, cables, sensor and other components that is selected from a plurality of battery system design data.

A design may be validated in a validation system 232. The validation system 232 may receive the selected battery system design and together with experimental data 234 and empirical data 236 may be used for validating the design and reselecting various parametric selectors 218. The simulation model may therefore be refined by various parametric selectors selected at the parametric selector 218 for selecting various material property and boundary conditions 215. The validation of the simulation is performed in step 322. When the validation is not successful in step 324, the parametric selector 218 is used for selecting various material property and boundary conditions 215. When the validation is successful in step 324, a detailed report may be generated by a report generator 240 with a battery design, various results and analysis. The report may include tables, charts, graphs, flowcharts that illustrate the data findings. The report and design are displayed on a display 242.

The system and method set forth in FIGS. 2 and 3 provide several advantages over traditional approaches. Faster and more cost effective design iterations enable comprehensive testing under a wide range of conditions that lead to a safer, more reliable battery system. By leveraging virtual engineering physics simulation tools, a deeper understanding of the complex thermal behavior of the high voltage batteries in electric vehicles is provided. The system and method provide an efficient approach to design and customize thermal protection and management systems that can improve battery life, reduce safety hazards, enhance overall performance in a cost effective, efficient, safe and reliable way. Compared to the hit-and-miss approaches previously applied, the present system allows rapid iteration and optimization of designs. By providing various experimental data as well as empirical module, a reduction in potential thermal issues may be provided. A designer may use the report to improve the placement of cooling elements or adjust various control strategies for actively cooling the battery system. Therefore, the optimized design leads to a more effective and efficient thermal management system that is tailored for the specific needs of the vehicle. In summary, the present disclosure provides a more efficient, cost-effective, comprehensive approach for designing thermal protection and management system for high voltage batteries in electric vehicles. The present disclosure addresses various shortcomings and previous methods and allows a rapid and efficient opportunity for optimization and innovation.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method comprising:
generating a geometric model for a battery system based on a plurality of design requirement data;
analyzing the geometric model with an engineering physics simulation tool;
performing a parametric analysis of the geometric model of the battery system using material properties and boundary conditions to obtain a plurality of battery system design data; and
selecting a selected battery system design from the plurality of battery system design data based on selection characteristics.

2. The method of claim 1 wherein generating the geometric model comprises generating the geometric model from at least three of battery size, a battery shape, a battery weight, a battery capacity, battery power, energy density, operating temperature range, and cooling method.

3. The method of claim 1 wherein generating the geometric model comprises generating the geometric model from a battery size, a battery shape, a battery weight, a battery capacity, battery power, energy density, operating temperature range, and cooling method.

4. The method of claim 1 wherein generating the geometric model comprises generating a three dimensional model of the battery system and a vehicle.

5. The method of claim 1 wherein generating the geometric model comprises generating a three dimensional model of the battery system and a vehicle comprising battery cells, battery modules, a battery pack, a connector, a cable, and a sensor.

6. The method of claim 1 wherein generating the geometric model comprises generating a three dimensional model of the battery system and a vehicle that includes battery cells, battery modules, and a battery pack.

7. The method of claim 1 wherein analyzing the geometric model comprises analyzing the geometric model based on at least one of electrical phenomena, thermal phenomena, mechanical phenomena and chemical phenomena of the battery system.

8. The method of claim 1 wherein performing the parametric analysis comprises performing the parametric analysis with vehicle operating conditions.

9. The method of claim 1 wherein performing the parametric analysis comprises performing the parametric analysis with vehicle operating conditions based on ambient temperature.

10. The method of claim 1 wherein performing the parametric analysis comprises performing the parametric analysis using material property and boundary conditions based on at least one of electrical conductivity, thermal conductivity, specific heat capacity, density, thermal expansion coefficient, heat generation rate and heat transfer coefficient.

11. The method of claim 1 wherein selecting the selected battery system design from the plurality of battery system design data is based on at least one of a minimized temperature gradient, a maximized uniformity of a state of charge, a maximized uniformity in the state of health, a reduction in power loss, and a reduction in internal resistance.

12. The method of claim 1 further comprising validating the selected battery system design.

13. The method of claim 12 wherein validating comprises validating based on experimental data, empirical data or both.

14. The method of claim 13 further comprising modifying design parameters at a parameter selector based on validating.

15. The method of claim 13 wherein modifying design parameters comprises modifying the design parameters based on at least one of a material property and a boundary condition.

16. The method of claim 14 wherein modifying design parameters comprises modifying material properties and boundary conditions.

17. The method of claim 1 further comprising generating a report comprising the selected battery system design and analysis reports.

18. A battery design system comprising:
a processor;
a non-transitory computer readable medium including machine readable instructions that are executable by a processor, said machine readable instructions include, generating a geometric model for a battery system based on a plurality of design requirement data;
analyzing the geometric model based with an engineering physics simulation tool;
performing a parametric analysis of the battery system model using material properties and boundary conditions to obtain a plurality of battery system design data; and
selecting a selected battery system design from the plurality of battery system design data based on selection characteristics.

19. The system of claim 18 wherein the instructions include generating the geometric model by generating the geometric model from at least three of battery size, a battery shape, a battery weight, a battery capacity, battery power, energy density, operating temperature range, and cooling method

20. The system of claim 18 wherein the instructions include performing the parametric analysis by performing the parametric analysis using material property and boundary conditions based on at least one of electrical conductivity, thermal conductivity, specific heat capacity, density, thermal expansion coefficient, heat generation rate and heat transfer coefficient.
